(19) United States
(12) Patent Application Publication
(10) Pub. No.: US 2025/0204316 A1
(43) Pub. Date: Jun. 26, 2025

(54) Crop Conditioning

(71) Applicant: AGCO Corporation, Duluth, GA (US)

(72) Inventors: Kevin J. Hamilton, Newton, KS (US); Donald Gilles, Hesston, KS (US)

(21) Appl. No.: 18/944,431

(22) Filed: Nov. 12, 2024

Related U.S. Application Data
(60) Provisional application No. 63/613,809, filed on Dec. 22, 2023.

(51) Int. Cl. A01D 43/10

(52) U.S. Cl. CPC A01D 43/102; A01D 43/105

(57) ABSTRACT

Systems and methods are provided for monitoring and controlling operation a conditioning system of or otherwise associated with an agricultural machine, which may include a mower conditioner. Sensor data indicative of a real-time displacement associated with component(s) of the conditioning system is used to determine a measured displacement, which is compared with a minimum displacement for the component(s). The comparison is used to control an operational parameter of one or more components associated with the conditioning system. The controllable component(s) can include the conditioning component(s), and the one or more controllers may be used to control the operational parameter (e.g. operational speed, position, etc.) of the conditioning components and ultimately a level of conditioning applied to cut crop material passing through the conditioning system.

### CROSS-REFERENCE TO RELATED APPLICATIONS

This application claims the benefit of the filing date of U.S. Provisional Patent Application 63/613,809, “Crop Conditioning,” filed Dec. 21, 2023, the entire disclosure of which is incorporated herein by reference.

### FIELD

Embodiments of the present disclosure relate generally to control systems and methods for an agricultural machine or components thereof, and specifically for monitoring and controlling operation of a conditioning system of or otherwise associated with the machine.

### BACKGROUND

An important process in the harvesting or collection of certain crops is the processing or “conditioning” of the material. Typically, for forage crops such as alfalfa and the like, the crop is cut and “conditioned” through application of a mechanical force to the crop material to encourage wilting and drying of the cut material.

Typical conditioning systems may employ conditioning rollers or rolls which are generally in the form of two rotatable rollers displaced from one another defining a “roll gap” therebetween. Through adjustment of the roll gap a level of conditioning applied to crop material passing between the rollers can be adjusted. Specifically, adjusting the roll gap changes the mechanical force applied to passing crop material and hence the level of conditioning applied thereto.

Different crops may require different levels of conditioning. Accordingly, in known arrangements an operator may make a manual adjustment (e.g. a mechanical adjustment using a wrench or the like) to the roll gap prior to a harvesting or cutting operation for a given crop. However, this is time consuming and typically is only done once ahead of the harvesting of a given field or another working environment. As such, it is not usually possible for the operator to account for changing field and/or conditions which may also require different conditioning levels or different conditioning settings for the conditioning system. For example, a higher crop throughput may necessitate different conditioning settings to apply the same desired level of conditioning to the crop material when compared with a low crop throughput. A wetter crop—i.e. one with a higher moisture content—may require an increased level of conditioning when compared with a drier crop.

It would therefore be advantageous to provide a system which may assist an operator in controlling operating settings for a conditioning system which overcomes or at least partly mitigates one or more problems associated with known systems.

### BRIEF SUMMARY

In an aspect of the disclosure there is provided a control system for adjusting a level of conditioning applied by a conditioning system of or otherwise associated with an agricultural machine, the control system comprising one or more controllers, and being configured to: receive sensor data indicative of a real-time displacement associated with one or more conditioning components of the conditioning system; determine a measured displacement in dependence on the received data; compare the measured displacement with a minimum displacement for the conditioning component(s); and generate and output one or more control signals for controlling an operational parameter of one or more components associated with the conditioning system in dependence on the comparison.

Advantageously, the present disclosure utilises a comparison of the measured displacement with a minimum displacement to control an operational parameter of one or more components associated with the conditioning system. At high crop loads, the one or more components may be forced from its minimum displacement and the control system may utilise the sensor data to identify movement or displacement of the component(s) from the minimum displacement and take appropriate action, here controlling an operational parameter of one or more components associated with the conditioning system. The displacement of the component(s) from the minimum displacement may be indicative of a crop flow or conditioning level applied to the material. Accordingly, the present solution provides a feedback loop for the conditioning system for at least partly automating control over the conditioning system or components associated therewith to control, e.g. a feed rate of material into or through the conditioning system, reducing operator workload and providing more uniform or at least a desired level of processing or conditioning to a crop material without the need for manual interaction by an operator.

The one or more controllers may collectively comprise an input (e.g. an electronic input) for receiving one or more input signals. The one or more input signals may comprise the sensor data. The one or more controllers may collectively comprise one or more processors (e.g. electronic processors) operable to execute computer readable instructions for controlling operational of the control system, for example, to determine the measured real-time displacement and/or compare the measured displacement with the minimum displacement. The one or more processors may be operable to generate one or more control signals for controlling operation of component(s). The one or more controllers may collectively comprise an output (e.g. an electronic output) for outputting the one or more control signals.

The one or more conditioning components may comprise one or more conditioning rollers. The one or more conditioning components may comprise a pair of conditioning rollers.

The measured displacement may comprise a roller gap. This may be a distance between conditioning rollers of the conditioning system.

The sensor data may be received from one or more sensors mounted or otherwise coupled in association with the conditioning system for monitoring one or more parameters associated with the operation of the conditioning system. The one or more sensors may include a rotary potentiometer providing a comparable sensor output in dependence on the position or displacement of the one or more conditioning components.

The one or more controllers may be configured to access, e.g. in a memory associated with the controller(s), stored base value for the sensor(s) corresponding to a baseline measurement for a control position or the minimum displacement of the conditioning component(s). The one or more controllers may be configured to compare the sensor output with the base value to determine the measured displacement of the conditioning component(s).

The minimum displacement may comprise a set value, e.g. which may be stored in a memory accessible by the one or more controllers. The memory may be local to the one or more controllers or may comprise a remote memory, such as a remote or cloud based server. Advantageously, the control system may be communicable with the remote or cloud based server over a wireless communication network. This may also enable the memory to be accessible by additional devices, such as a user device—e.g. where a desired or target minimum displacement may be input on a user device separate from the machine.

The minimum displacement may be predefined or may be adjustable. In some embodiments the conditioning component(s) may be provided with a shim stop defining the minimum displacement for the components(s). In some embodiments the minimum displacement is user adjustable. The conditioning system may comprise an actuator arrangement for controlling the position of the component(s). The actuator arrangement may be controllable to define the minimum displacement.

The minimum displacement may be determined or definable in dependence on a crop type to be processed by the conditioning system. The one or more controllers may be configured to receive a user input, e.g. via a user interface of or otherwise associated with the control system, related to the minimum displacement. This may comprise a user input of the crop type, for example, or may comprise a user selected minimum displacement.

The user interface, where present, may comprise a user device, e.g. a phone, tablet computer or the like carried by an operator of the machine and communicably linked to the one or more controllers, e.g. over a wireless communications network. In other embodiments, the user interface may comprise a display terminal of the agricultural machine, for example.

The operational parameter for the component(s) may comprise an operational speed. Controlling the operational speed of the component(s) associated with the conditioning system may include controlling an operational speed of one or more conditioning rollers of the conditioning system. Advantageously, the control system may be configured to control the operational speed of the conditioning system or one or more components thereof in dependence on the comparison of the measured displacement with the minimum displacement. A higher operational speed may handle higher crop loads more efficiently and therefore be utilised, for example, where there is a relatively large difference between the minimum displacement and the measured displacement. Conversely, it may be beneficial to reduce the operational speed at lower crop loads (e.g. where the difference between the minimum and measured displacement is relatively smaller) to ensure adequate conditioning of the crop, and/or for efficiency or fuel consumption optimization.

Controlling the operational speed of the component(s) associated with the conditioning system may include controlling a feed rate of crop material to and/or through the conditioning system. The one or more components controllable by the one or more controllers may include a feed or “helper” roller for controlling a feed rate of material to the conditioning system.

The one or more controllers may be configured to return the operational speed of the one or more controllable components to a control or target operational speed in dependence on the measured displacement returning a given range of the minimum displacement.

The one or more controllers may be configured to control operation of a speed control subsystem for controlling the operational speed of the component(s) associated with the conditioning system. The speed control subsystem may include a drive system, such as a variable belt drive. The speed control subsystem may include a hydraulic control system, which may include hydraulic control of a motor speed associated with the controllable components.

The operational speed may comprise a relative operational speed. The control system may be operable to account for a forward speed of the agricultural machine in determining the operational speed for the controllable component. For instance, a higher forward speed for the machine may provide a higher feed rate for crop material when compared with a lower forward speed. Accordingly, the control system may be configured to adjust an operational speed of the component(s) relative to the forward speed of the agricultural machine, e.g. to achieve a desired feed rate or process rate for crop material through a conditioning system of the machine.

In further embodiments the one or more controllers may be configured to receive additional sensor data indicative of an operational speed of the one or more components associated with the conditioning system. This may include sensor data from a speed sensor operably coupled to the controllable component(s). The speed sensor may include a hall-effect sensor, for example. The one or more controllers may be configured to utilise the monitored speed in a feedback loop for controlling the operational speed of the component(s)—e.g. for confirming the actual operational speed is in line with the controlled or desired operational speed as determined and controlled by the control system.

In some embodiments the operational parameter relates to a level of tensioning applied by a component positioning system for the conditioning component(s). Hence, the control system may be configured to control operation of the component positioning system for the conditioning component(s) in dependence on the comparison. The component positioning system may comprise one or more actuators for controlling the displacement of the component(s). The one or more actuators may form part of a fluid (e.g. hydraulic or pneumatic) drive control system. The one or more controllers may be configured to adjust a control pressure associated with the fluid drive control system of the component positioning system in dependence on the comparison of the measured displacement with the minimum displacement.

In embodiments the component positioning system may control a level of tensioning applied to the one or more components. The one or more controllers may be configured to adjust a level of tensioning applied by the component positioning system in dependence on the comparison of the measured displacement with the minimum displacement. For example, adjusting the control pressure may include increasing a pressure level where the difference between the measured displacement and the minimum displacement is relatively large to increase a level of tensioning applied by the component positioning system to the one or more components. This may, e.g. increase an effective level of conditioning applied to the crop material by the conditioning system, which may be necessary at higher crop loads, for example. In embodiments, adjusting the control pressure may include decreasing a pressure level where the difference between the measured displacement and the minimum displacement is relatively smaller to decrease a level of tensioning applied by the component positioning system to the one or more components. This may, e.g. decrease a level of conditioning applied to the crop material by the conditioning system, which may be beneficial at lower crop loads, for example.

The control system may additionally be configured to employ a filtering or buffering mechanism. The filtering or buffering mechanism may advantageously filter, remove or account for small or abrupt changes in the monitored conditioning component displacement when determining any adjustment to make to, for example, a speed control subsystem, a tensioning mechanism, or other component associated with the conditioning component(s). This may advantageously account for anomalies such as rocks or other debris moving between the conditioning components causing a temporary change in the measured component displacement. This may take the form of a delay or timer for active control over the operational component speed, or a dampening on the response rate such that the control system provides a smooth transition between operational states, where necessary.

A further aspect of the disclosure provides a conditioning system for an agricultural machine, comprising: one or more moveable crop engaging components; and the control system of any preceding aspect, operable in use for controlling an operational parameter of one or more components associated with the conditioning system to control a level of conditioning applied by the one or more moveable crop engaging components in dependence on a comparison of a measured real-time displacement of the crop engaging component(s) with a minimum displacement.

Another aspect provides an agricultural machine comprising the conditioning system and/or comprising or being controllable under operation of the control system of any preceding aspect.

The agricultural machine may comprise a self-propelled machine having the conditioning system forming part of the machine. The agricultural machine may comprise a baler, mower, harvester, or windrower, for example.

In other embodiments, the agricultural machine may comprise a vehicle-implement combination. For example, the machine may comprise a tractor or other vehicle with the implement operably coupled (e.g. towed) thereto. The conditioning system may be provided as part of the implement, and its operation may be controlled by the control system which may, in embodiments be hosted on the vehicle or the implement or distributed across both the vehicle and the implement.

A further aspect of the disclosure provides a computer implemented method for adjusting a level of conditioning applied by a conditioning system of or otherwise associated with an agricultural machine, the method comprising: determining a measured real-time displacement associated with one or more conditioning components of the conditioning system; comparing the measured displacement with a minimum displacement for the conditioning component(s); and controlling an operational parameter of one or more components associated with the conditioning system in dependence on the comparison.

The method may comprise performance of one or more operational tasks performable by the one or more controllers of a control system described herein.

A further aspect provides computer software comprising computer readable instructions which, when executed, cause performance of any method described herein.

A yet further aspect provides a non-transitory computer readable storage medium comprising the computer software of any+preceding aspect.

Within the scope of this application it should be understood that the various aspects, embodiments, examples, and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

### BRIEF DESCRIPTION OF THE DRAWINGS

One or more embodiments of the disclosure/disclosure will now be described, by way of example only, with reference to the accompanying drawings, in which:

FIG. 1 is a perspective view of an agricultural machine embodying aspects of the present disclosure;

FIG. 2 is a schematic illustration of the agricultural machine shown in FIG. 1; and

FIG. 3 is a schematic illustration of a control system of the present disclosure.

### DETAILED DESCRIPTION

The present disclosure relates to systems and methods for monitoring and controlling operation a conditioning system 28 of or otherwise associated with an agricultural machine, illustrated herein in the form of as a mower conditioner 10. Sensor data is received from sensors operably coupled to one or more conditioning components, here conditioning rollers 36, of the conditioning system 28, the sensor data being indicative of a displacement associated with the component(s). The measured displacement is compared with a minimum displacement for the component(s) and such a comparison is used to control an operational parameter of one or more component(s) associated with the conditioning system, e.g. the conditioning rollers 36 themselves, and/or a feed or helper roller 22 for controlling a flow rate of material through the conditioning system 28 and/or a level of conditioning applied to cut crop material passing through the rollers 36. Advantageously, a measured displacement of the rollers 36, e.g. due to changes in crop load, can be used in a feedback loop for controlling operation of certain operable components to ensure a desired level of conditioning is applied to the cut crop material even at different crop loads, different crop or field conditions, and the like.

### Agricultural Machine

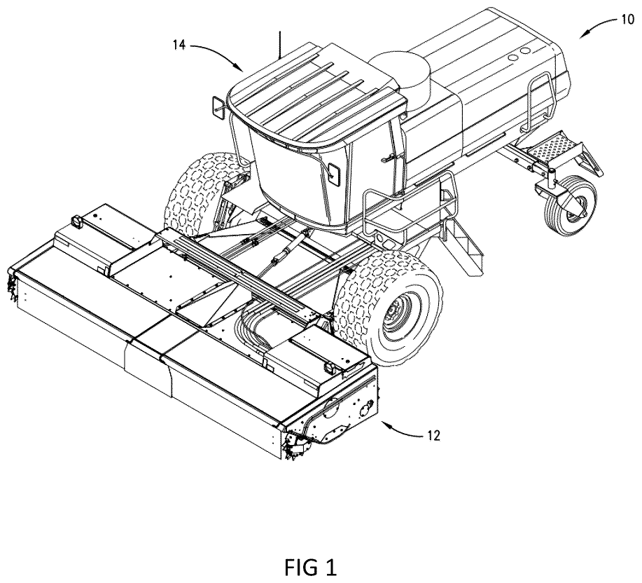

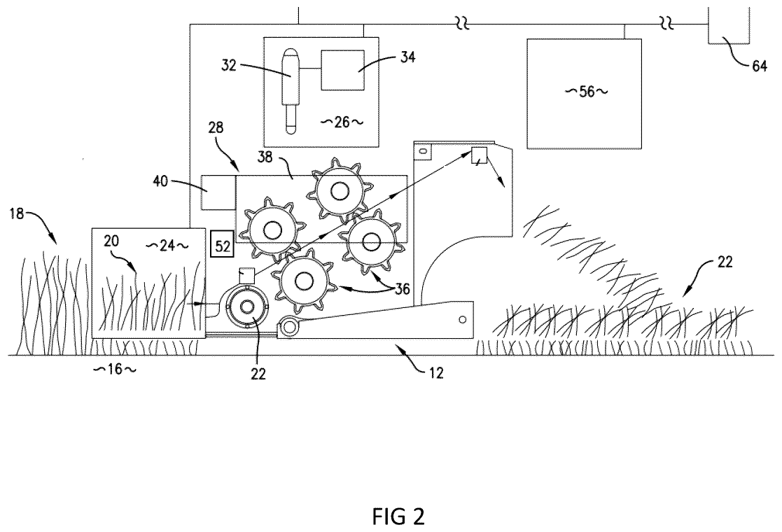

Referring to FIGS. 1 and 2, an exemplary agricultural machine in the form of a mower conditioner 10 (also referred to herein interchangeably as a “mower”) is illustrated. The illustrated mower conditioner 10 is self-propelled and includes a header 12 coupled the front thereof for cutting crop material, as will be appreciated. Specifically, the header 12 is moved over a field 16 of standing crop material 18, used to cut the crop material from the ground, condition the cut crop material 20 as it passes rearwardly through the header 12, and then return the conditioned crop material to the ground in the form of windrows or swathes 22 for drying and subsequent collection.

Referring specifically to FIG. 2, the header 12 includes a crop cutting assembly 24, a lift mechanism 26, and a conditioning system 28. The crop cutting assembly 24 is configured to cut the crop material from the ground. The crop cutting assembly 24 may employ substantially any suitable crop cutting technology, such as a conventional rotary-type cutter bed or a conventional sickle-type cutter bed. Such an arrangement will be readily understood by the skilled reader. Here, a “helper” roller 22 is provided for urging the cut crop material rearward toward the conditioning system 28, however again the skilled reader will appreciate that a number of different configurations may be employed.

The lift mechanism 26 is configured to raise and lower at least the crop cutting assembly 24 to a desired cutting height during operation, and to raise and lower the entire header 12 to, respectively, a non-operational transport height and an operational height. The lift mechanism 26 may employ substantially any suitable lifting technology, such as a hydraulic mechanism or a mechanical mechanism. Again, such an arrangement will be understood. Here, the lift mechanism 26 includes a lift cylinder 32 and a hydraulic lift circuit 34 configured to control the movement of hydraulic fluid to and from the lift cylinder 32 to, respectively, raise and lower the crop-cutting assembly 24 and/or the header 12. In some embodiments, the lift mechanism 26 is provided alongside a tilt mechanism for adjusting a “tilt” or “pitch” of the crop cutting assembly 24.

The conditioning system 28 is configured to receive and condition the cut crop material from the crop cutting assembly 24. The conditioning system 28 may employ substantially any suitable conditioning technology. Here, the conditioning system 28 includes one or more pairs of counter-rotating conditioning rollers 36 configured to “condition” the crop material. That is, as the cut crop material passes between the rollers 36, a mechanical force is applied to the material, crushing, pressing and/or crimping the material to encourage drying of the crop. To enable control over the level of conditioning applied by the rollers 36, a component positioning system in the form of tensioning mechanism 38 may be provided. Specifically, the tensioning mechanism 28 is configured to adjustably urge the paired rollers 36 toward one another and resist their separation, and a gap setting mechanism 40 is configured to set an adjustable gap between the paired rollers 36 as is described herein.

The conditioning rollers 36 may have relatively non-compressible surfaces made of a hard material and may take the form of fluted or ribbed steel rollers. Alternatively, the rollers 36 may have relatively compressible surfaces made of rubber or a combination of rubber and steel. Each roller may have a series of radially outwardly projecting ribs that extend along the length of the roller in a helical pattern. The ribs may be spaced around each roller in such a manner that the ribs on one roller intermesh with the ribs of the other paired roller during operation in order to crimp the cut crop material. Alternatively, the rollers may be non-intermeshing in order to crush rather than crimp the cut crop material. It will be appreciated here that the present disclosure is not limited in the construction of the roller surface, and this description is provided by way of example only.

Each pair of conditioning rollers 36 may be mounted in such a way that the one roller 36 is moveable toward and away from the other paired roller 36, while the position of the latter remains fixed. Alternatively, both rollers may be moveable toward and away from each other. Again, the present disclosure is not limited in this sense.

The tensioning mechanism 38 is configured to adjust a force on one or both of the paired rollers 36 to urge the rollers together to an extent permitted by the gap setting mechanism 40 which sets a running gap between or “displacement” of each pair of rollers 36. The tensioning mechanism 38 may employ substantially any suitable technology, such as hydraulic tensioning technology or spring tensioning technology. In the present embodiment, a hydraulic actuator is employed, and the control system 100 (described in detail below) may be configured in some variants to control a hydraulic pressure associated with the tensioning mechanism 38, e.g. in dependence on a monitored or measured displacement of the rollers 36 and specifically its comparison with a minimum displacement of the rollers 36.

A speed control unit 64 is provided for controlling an operational speed of one or more components associated with the conditioning system 28. In the illustrated embodiment this comprises a hydraulic control unit for controlling an operational speed of a motor associated with one or more of the conditioning rollers 36, and in turn a rotational or working speed of the rollers 36 themselves. In the present embodiment, the control system 100 is configured to control the hydraulic control unit, e.g. Through controlling of signal output, hydraulic pressure etc. for controlling the operational speed of the rollers 36 in dependence on the monitored or measured displacement of the rollers, as is described further below.

The present system further employs a sensing system, here in the form of sensor 52 operably coupled to one of the conditioner rollers 36 for obtaining a measure of a displacement associated with the roller 36. Sensor 52 takes the form of a rotary potentiometer providing a comparable voltage output which is proportional to the position of the roller 36. By utilising a base or control measurement/voltage for a known position—e.g. fully closed—the displacement or position of roller 36 can be inferred from the voltage output of sensor 52. Alternative sensing equipment may be used, as will be appreciated by the skilled reader. For instance, the sensor may include a rotary or angular sensor having a current output or CAN based output, a non-contact sensor such as a hall effect sensor or the like, again with any means of readable output, or a sliding or linear sensor for monitoring roller position/displacement.

### Operational Use

As described, in use crop material 18 is cut from the field utilising crop cutting assembly 24. The cut crop material is passed via one or more rollers, including conditioning rollers 36 to condition the material through application of an appropriate mechanical force to crush or crimp the material to encourage, amongst other things, adequate drying of the crop when placed in a swath behind the machine. Adequate drying may relate to an overall moisture content for the crop, and/or a uniformity of the drying rate across different crop components, for example, between stems and leaves of a crop (e.g. alfalfa crop).

To adjust the level of conditioning applied by the conditioning system 28, gap setting mechanism 40 is used to provide a level of tensioning to the conditioning rollers 36, allowing them to be moveable or displaced from one another between a minimum displacement, which may be defined by a hard shim stop and a maximum displacement which is largely related to the level of tensioning provided by the tensioning mechanism 38. The minimum displacement may be preset, it may be adjustable manually by an operator e.g. through mechanical interaction with the gap setting mechanism 40 utilising appropriate tooling, or in some instances through input of a desired or target minimum roller gap utilising, for example, a user interface 56 provided as part of the mower 10. The minimum displacement may be dependent on a number of factors, including crop type, crop conditions, field conditions and the like, as will be appreciated. The starting position of the rollers 36 may then set according to this gap. The minimum gap may also be adjustable “on-the-go”, that is during operation, e.g. through interaction with the user interface by the operator, where different crop conditions or field conditions necessitate an adjustment in the roll gap, for instance.

In use, once crop material is passing through the rollers, the operating gap between the rollers 36 may increase or decrease based on crop load. For instance, at high loads, the gap may increase due to the additional material. With the rollers at a greater displacement, an inadequate level of conditioning may be applied to the material. The present disclosure therefore monitors the operational gap or displacement of rollers 36 relative to the minimum displacement utilising sensor 52 and uses this to control an operational parameter associated with one or more components associated with the conditioning system 28, which here, as discussed, may include controlling a rotational speed of the conditioning rollers 36, or a level of tensioning provided by the tensioning mechanism 38. For instance, the control system 100 may be operable to increase a rotational speed of the roller(s) 36 at higher crop loads, as determined or at least inferred by an increase in the roller displacement from the minimum displacement. In turn, this may increase the flow of material through the conditioning system to overcome the increased displacement of the rollers 36.

Conversely, if the mower 10 were then to enter into a lower yield region of the working environment, or a region requiring a lower level of conditioning due to crop or field conditions, for example, an inadequate conditioning of the crop material may be applied at higher operational speeds of the rollers 36. Further, it may be beneficial to reduce the operational speed of the rollers 36 for efficiency and/or fuel consumption purposes. Accordingly, for low crop yield areas, e.g. as inferred through a reduction in the displacement of the rollers 36, the speed of the rollers may be decreased, or returned to a target value e.g. when moving back into a target displacement range.

Additionally or alternatively, further operational parameters may be controlled in dependence on the comparison of the measured roller gap with the minimum displacement, for instance a level of tensioning applied to the rollers 36 by the tensioning mechanism as discussed above. For instance, this may include control of the tensioning mechanism 38 to increase a hydraulic pressure associated with a hydraulic actuator for the roller(s) 36, thereby increasing a tensioning applied to the relevant roller(s) 36 and resisting this increase in displacement, in turn reducing the difference between the monitored roller gap and the minimum displacement. Conversely, where it is determined that the tensioning mechanism 38 may be applying too great a level of tensioning to the roller(s) 36, e.g. dependent on crop load, crop type or other conditions, the roller(s) displacement may be too small resulting in over conditioning of the crop material. Accordingly, the present disclosure may monitor the displacement of the roller(s) 36 in use with respect to the minimum displacement, and optionally utilising further information, such as crop type, load, or the like and control operation of the tensioning mechanism 38 accordingly. Specifically, this may include control of the tensioning mechanism 38 to decrease a hydraulic pressure associated with a hydraulic actuator for the roller(s) 36, thereby decreasing a tensioning applied to the relevant roller(s) 36 and allowing the rollers 36 to move further apart and away from the minimum displacement where the circumstances require.

### Control System

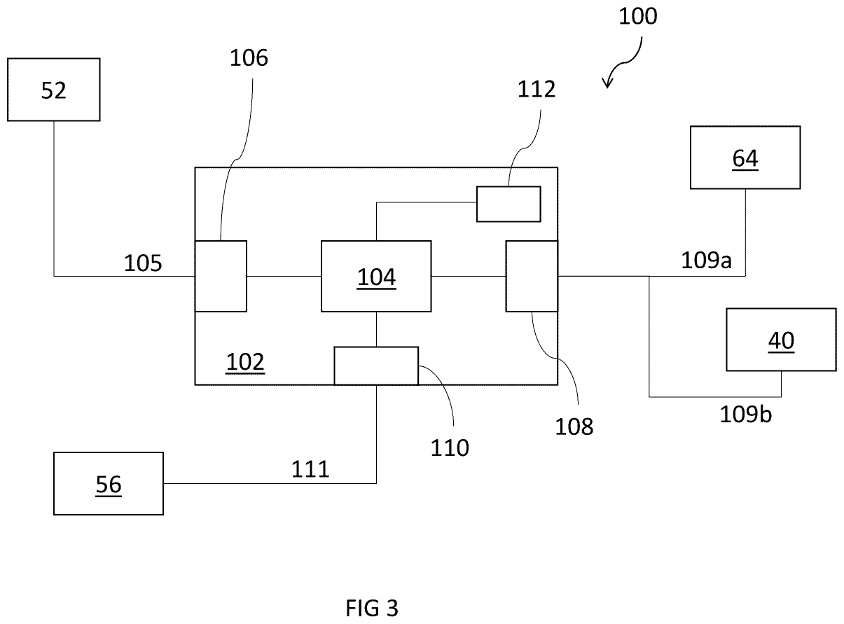

FIG. 3 illustrates system 100 of the present disclosure further. As shown, the system incorporates a control system 100 here having a single controller 102. The controller 102 includes an electronic processor 104, an electronic input 106 and electronic outputs 108, 110. The processor 104 is operable to access a memory 112 of the controller 102 and execute instructions stored therein to perform the steps and functionality of the present disclosure, for example to output control signals 109 via the output 108 for controlling the display terminal 32 of the mower 10, for example to provide an image or graphical representation to an operator of the mower 10 indicative of the measured displacement or other operational steps undertaken by the control system 100.

The processor 104 is operable to receive sensor data via input 106 which, in the illustrated embodiment, takes the form of input signals 105 received from sensor 52. As described in detail herein, the sensor 52 comprises a rotary potentiometer (although other sensing types will be apparent), with the sensor output comprising a voltage output indicative of the position or displacement of an associated conditioning roller 36. The processor 104 is operable to process the voltage output of the sensor 52 to determine a measure of the displacement and utilise this to control the operational speed of components associated with the conditioning system (e.g. rollers 36) based on the difference between the measured displacement and a minimum displacement, as described herein. Depending on the output of this comparison, operation of the speed control unit 64 and/or tensioning mechanism 38, and potentially other parameters, is controlled. Here, this includes control of a hydraulic pressure associated with the hydraulic control of the rollers 36/tensioning mechanism 38, or motor control for the speed control unit 64 in the manner described herein to control the level of conditioning applied by the rollers 36. To achieve this, output 108 is operably coupled to the speed control unit 64 for output of control signals 109a thereto, and to gap setting unit 40 for output of control signals 109b thereto, for enacting an appropriate control of the operable components.

Output 110 is operably coupled to a display terminal 32 of the mower 10. Here, the control system 100 is operable to control operation of the display terminal 32, e.g. through output of control signals 111 in order to display operational data to an operator of the mower 10 relating to the operation of the control system 100. Specifically, the control system 100 may be operable to control the display terminal 32 to display to the operator a graphical representation the roller displacement, or other useful information including notification of an adjustment being made for information purposes. In some variants, the display terminal 32 may also be operable to receive a user input from the operator, and in such instances the output 110 may act as an input for receiving that user input at the processor 104. The user input may relate to a requested or desired target minimum displacement for the conditioning system 28. This could include the operator setting a displacement directly, or inputting other information, e.g. crop type, expected moisture level etc. from which the minimum displacement is determined. As will be appreciated, further displays or user interfaces may be provided for providing operational details to the operator. This could include an interface provided on or proximal to the header or crop intake of the mower itself. This may be used to provide information relating to the desired or base roller displacement as is discussed herein.

### Alternative Embodiments

The control system 100 may additionally employ a filtering or buffering mechanism whereby small or abrupt changes in the monitored conditioning component displacement may be filtered in determining any adjustment to make to, for example, the tensioning mechanism. This may advantageously account for anomalies such as rocks or other debris moving between the conditioning rollers causing a temporary change in the roller displacement. This may take the form of a delay or timer for active control over the operational component speed, or a dampening on the response rate such that the control system 100 provides a smooth transition between operational states for the operable component(s).

In yet further alternative arrangements, display terminal 56 may instead be replaced or supplemented by a user device, e.g. a remote or portable user device which is communicably coupled with the control system 100. This may enable the operator to utilize a mobile phone or tablet computer, for example, to control operation of the control system 100, e.g. by inputting desired operational parameters including the target displacement via the user device.

Whilst described herein in relation to a mower conditioner 10, the skilled reader will appreciate that the described solution may be applied to any number of self-propelled agricultural machines which utilise conditioning equipment for the conditioning of crop material, such as forage crops. This may extend to balers, other mowers, harvesting equipment and the like. This may additionally extend to implements for performance of the same task, which are coupleable to other vehicles, including tractors and the like. Where hosted on an implement rather than a self-propelled machine, the control aspects may in some instances be provided locally, or be provided by the towing or coupled vehicle, and a suitable communication link between the vehicle and the implement may be established to enable control of operable components of the implement from the vehicle, and vice versa.

### General

Any process descriptions or blocks in flow diagrams should be understood as representing modules, segments, or portions of code which include one or more executable instructions for implementing specific logical functions or steps in the process, and alternate implementations are included within the scope of the embodiments in which functions may be executed out of order from that shown or discussed, including substantially concurrently or in reverse order, depending on the functionality involved, as would be understood by those reasonably skilled in the art of the present disclosure.

It will be appreciated that embodiments of the present disclosure can be realized in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device, or integrated circuits or on an optically or magnetically readable medium such as, for example, a CD, DVD, magnetic disk, or magnetic tape. It will be appreciated that the storage devices and storage media are embodiments of machine-readable storage that are suitable for storing a program or programs that, when executed, implement embodiments of the present disclosure. Accordingly, embodiments provide a program comprising code for implementing a system or method as set out herein and a machine readable storage storing such a program. Still further, embodiments of the present disclosure may be conveyed electronically via any medium such as a communication signal carried over a wired or wireless connection and embodiments suitably encompass the same.

All references cited herein are incorporated herein in their entireties. If there is a conflict between definitions herein and in an incorporated reference, the definition herein shall control.

What is claimed is:

1. A control system for adjusting a level of conditioning applied by a conditioning system of or otherwise associated with an agricultural machine, the control system comprising one or more controllers, and being configured to:
receive sensor data indicative of a real-time displacement associated with one or more conditioning components of the conditioning system;
determine a measured displacement in dependence on the received data;
compare the measured displacement with a minimum displacement for the conditioning component(s); and
generate and output one or more control signals for controlling an operational parameter of one or more components associated with the conditioning system in dependence on the comparison;
wherein the operational parameter comprises an operational speed of the component(s); and
controlling the operational speed of the component(s) associated with the conditioning system includes controlling an operational speed of the one or more conditioning components.

2. A control system of claim 1, wherein the one or more conditioning components comprise one or more conditioning rollers.

3. A control system of claim 2, wherein the one or more conditioning components comprise a pair of conditioning rollers.

4. A control system of claim 2, wherein the measured displacement comprises a roller gap.

5. A control system of claim 1, wherein the sensor data is received from one or more sensors mounted or otherwise coupled in association with the conditioning system for monitoring one or more parameters associated with the operation of the conditioning system.

6. A control system of claim 5, wherein the one or more sensors include a rotary potentiometer providing a comparable sensor output in dependence on the position of the one or more conditioning components.

7. A control system of claim 1, wherein the minimum displacement is predefined, is determined in dependence on a crop type to be processed by the conditioning system, and/or is determined in dependence on a user input.

8. A control system of claim 1, wherein the one or more conditioning components comprise one or more conditioning rollers, and wherein the one or more controllers are configured to control the operational speed of the conditioning roller(s) in dependence on the comparison.

9. A control system of claim 1, wherein controlling the operational speed of the component(s) associated with the conditioning system comprises controlling a feed rate of crop material to and/or through the conditioning system.

10. A control system of claim 9, wherein the one or more controllers are configured to control an operational speed of a feed roller for controlling a feed rate of material to the conditioning system.

11. A control system of claim 1, wherein the operational parameter relates to a level of tensioning applied by a component positioning system for the conditioning component(s).

12. A control system of claim 11, wherein the component positioning system comprises one or more actuators for controlling the displacement of the component(s).

13. A control system of claim 12, wherein the one or more actuators form part of a fluid drive control system; and wherein the one or more controllers are configured to adjust a control pressure associated with the fluid drive control system of the component positioning system in dependence on the comparison of the measured displacement with the minimum displacement.

14. A control system of claim 13, wherein the component positioning system is configured to control a level of tensioning applied to the one or more components; and wherein the one or more controllers are configured to adjust a level of tensioning applied by the component positioning system in dependence on the comparison of the measured displacement with the minimum displacement.

15. A conditioning system for an agricultural machine, comprising:
one or more moveable crop engaging components; and
the control system of any preceding claim, operable in use for controlling an operational parameter of one or more components associated with the conditioning system to control a level of conditioning applied by the one or more moveable crop engaging components in dependence on a comparison of a measured real-time displacement of the crop engaging component(s) with a minimum displacement.

16. An agricultural machine comprising the conditioning system of claim 15.

17. An agricultural machine comprising or being controllable under operation of the control system of claim 1.

18. A computer implemented method for adjusting a level of conditioning applied by a conditioning system of or otherwise associated with an agricultural machine, the method comprising:
determining a measured real-time displacement associated with one or more components of the conditioning system;
comparing the measured displacement with a minimum displacement for the component(s); and
controlling an operational parameter of one or more component(s) associated with the conditioning system in dependence on the comparison;
wherein the operational parameter comprises an operational speed of the component(s); and
controlling the operational speed of the component(s) associated with the conditioning system includes controlling an operational speed of the one or more conditioning components.
